(19) United States
(12) Patent Application Publication
(10) Pub. No.: US 2026/0301129 A1
(43) Pub. Date: Oct. 1, 2026

(54) COLOR TRANSFORMATION SYSTEM AND MODEL FOR A VEHICLE

(71) Applicant: GM Global Technology Operations LLC, Detroit, MI (US)

(72) Inventors: Manoj Kumar Sharma, Troy, MI (US); Kamran Ali, Troy, MI (US); Donald K. Grimm, Utica, MI (US); Fahim Ahmed, Troy, MI (US)

(73) Assignee: GM Global Technology Operations LLC, Detroit, MI (US)

(21) Appl. No.: 19/077,966

(22) Filed: Mar. 12, 2025

(51) Int. Cl. G06T 5/60; B60R 1/22

(52) U.S. Cl. CPC G06T 5/60; B60R 1/22; B60R 2300/30; B60R 2300/80; G06T 2207/10024; G06T 2207/20012; G06T 2207/20081; G06T 2207/30252

(57) ABSTRACT

A computer-implemented method when executed by data processing hardware causes the data processing hardware to perform operations. The operations include receiving, at a color transformation model, image data from one or more imagers of a vehicle, identifying, based on the image data, at least one target, and generating a region of interest of the image data based on and proximate to the identified target. The operations also include executing, via the color transformation model, color transformation of the generated region of interest including the at least one target, outputting, via the color transformation model, a transformed region of interest having an altered color than the generated region of interest, and displaying the transformed region of interest at a user interface of the vehicle.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to a color transformation system and model for a vehicle.

Colorblind individuals may experience issues with color differentiation, which may be particularly difficult during operation of a vehicle. For example, a colorblind individual may have increased difficulty in identifying road signs or other colorized objects that may impact the operation of the vehicle. A solution to assist color-blind individuals is to apply a daltonization effect to an image field. Daltonization is a process that adjusts colors in an image to make the colors more distinguishable to colorblind individuals. However, the daltonization process applies generic adjustments that do not account for the varying degrees and types of color blindness. Further, traditional daltonization is not configured to be tailored to an individual. Traditional daltonization may also have trouble in providing clarity and distinction between elements in complex images. Thus, there is a need for an improved method of adjusting image outputs for colorblind individuals.

### SUMMARY

In some aspects, a computer-implemented method when executed by data processing hardware causes the data processing hardware to perform operations. The operations include receiving, at a color transformation model, image data from one or more imagers of a vehicle, identifying, based on the image data, at least one target, and generating a region of interest of the image data based on and proximate to the identified target. The operations also include executing, via the color transformation model, color transformation of the generated region of interest including the at least one target, outputting, via the color transformation model, a transformed region of interest having an altered color than the generated region of interest, and displaying the transformed region of interest at a user interface of the vehicle.

In some examples, identifying the at least one target may include executing a target detection model. Optionally, generating the region of interest may include applying a preset padding to the identified at least one target. In some instances, executing the color transformation may include executing a localized daltonization function on the region of interest. In other examples, executing the color transformation may include executing a localized generative adversarial network (GAN) function on the region of interest. Optionally, executing the localized GAN function may include identifying a user profile and customizing the color transformation based on the user profile. The operations may also include training a machine learning model of the color transformation model with paired images, the paired images including standard images and color adjusted images.

In other aspects, a color transformation system for a vehicle includes data processing hardware and memory hardware in communication with the data processing hardware. The memory hardware stores instructions that, when executed on the data processing hardware, cause the data processing hardware to perform operations. The operations include receiving, at a color transformation model, image data from one or more imagers of the vehicle, identifying, based on the image data, at least one target, and generating, via a target detection model, a region of interest of the image data based on and proximate to the identified target. The operations also include cropping, via the color transformation model, the image data at the generated region of interest, executing, via the color transformation model, a localized daltonization function on the region of interest to define a transformed region of interest, and replacing the generated region of interest of the image data with the transformed region of interest, the transformed region of interest having an altered color than the generated region of interest.

In some examples, the operations may also include uploading the image data to an image processing library stored in the memory hardware. In other instances, generating the region of interest may include extracting, via the color transformation model, coordinates of the region of interest. The operations may also include generating, via the target detection model, padded coordinates of preset padding. Optionally, replacing the region of interest with the transformed region of interest may include inserting the transformed region of interest into an original image of the image data to define a modified image. The operations may further include saving the modified image to an output path of the color transformation model. In some instances, identifying the at least one target includes comparing the image data with a target database. The operations may also include receiving, at the target detection model, object types based on the comparison of the image data with the target database, the object types including the at least one target.

In further aspects, a color transformation for a vehicle includes data processing hardware and memory hardware in communication with the data processing hardware. The memory hardware stores instructions that, when executed on the data processing hardware, cause the data processing hardware to perform operations. The operations include receiving, at a color transformation model, image data from one or more imagers of the vehicle, identifying, based on the image data, at least one target, generating, via a target detection model, a region of interest of the image data based on and proximate to the identified target, and executing, via the color transformation model, a machine learning function of a machine learning model. The operations also include mapping, via the machine learning function, an input image from the image data to an output image, the output image corresponding to a color adjusted image, cropping, via the color transformation model, the image data at the generated region of interest, executing, via the color transformation model, a localized generative adversarial network (GAN) function on the region of interest to define a transformed region of interest, and replacing the generated region of interest of the image data with the transformed region of interest, the transformed region of interest having an altered color than the generated region of interest.

In some examples, executing the localized GAN function may include identifying a user profile and customizing the color transformation based on the user profile. The operations may also include training a machine learning model of the color transformation model with paired images, the paired images including standard images and color adjusted images. The operations may further include passing the cropped image data through the trained machine learning model. Optionally, executing the localized GAN function may include generating the transformed region of interest using the trained machine learning model.

### BRIEF DESCRIPTION OF THE DRAWINGS

The drawings described herein are for illustrative purposes only of selected configurations and are not intended to limit the scope of the present disclosure.

FIG. 1 is a schematic of a vehicle equipped with a color transformation system according to the present disclosure;

FIG. 2 is an exemplary block diagram of a color transformation system according to the present disclosure;

FIG. 3 is an exemplary block diagram of a color transformation system according to the present disclosure, the color transformation system configured with a color transformation model including a localized daltonization function;

FIG. 4 is an exemplary block diagram of a color transformation system according to the present disclosure, the color transformation system configured with a color transformation model including a localized generative adversarial network (GAN) function;

FIG. 5 is an example flow diagram of execution of a color transformation system according to the present disclosure; and

FIG. 6 is an example flow diagram of a method of operation of a color transformation system according to the present disclosure.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

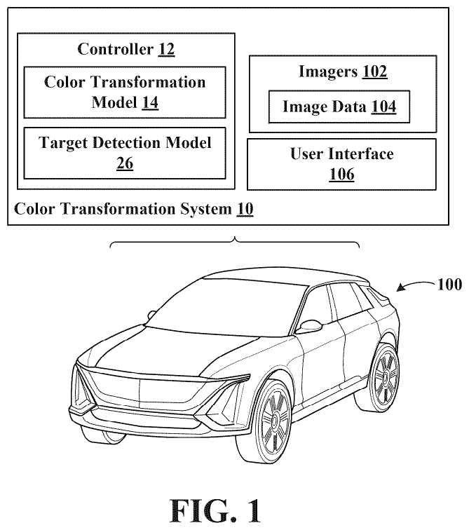

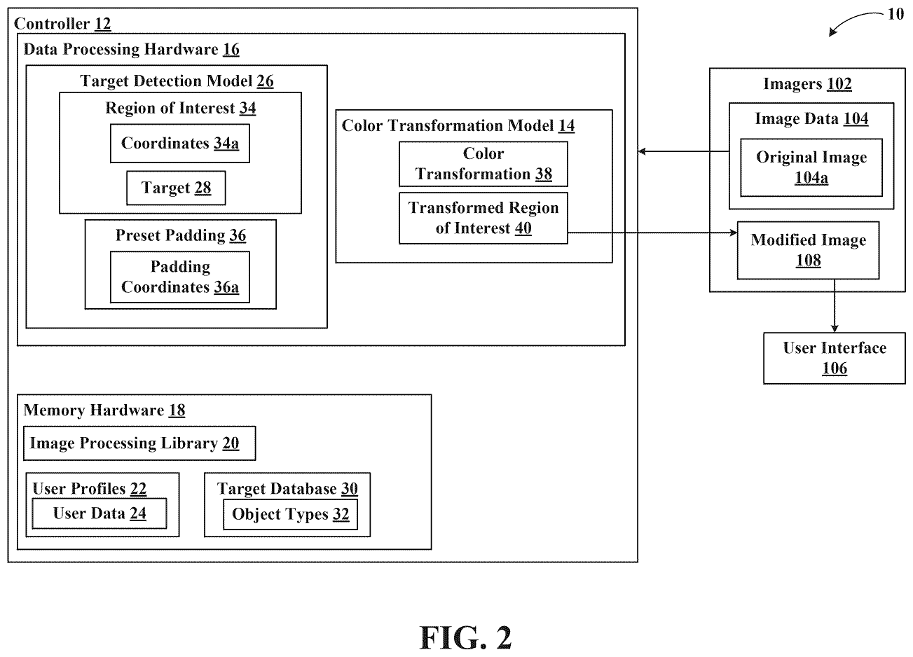

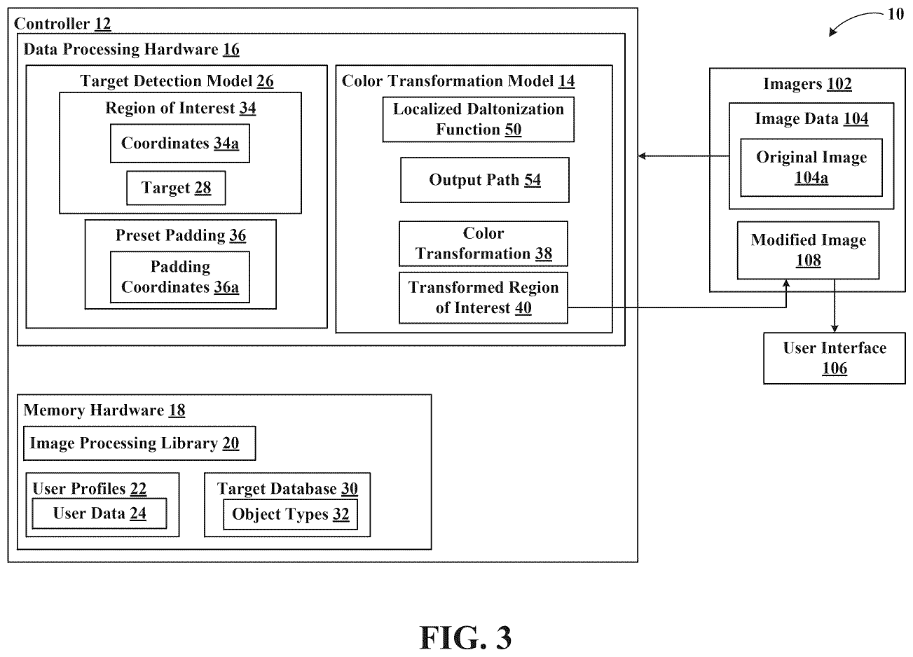

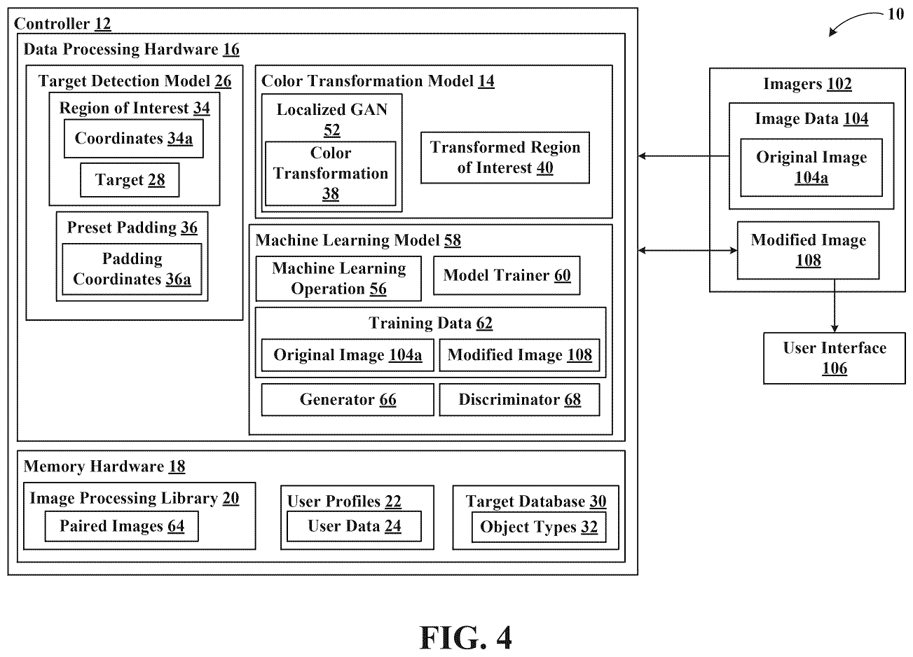

Referring to FIGS. 1-4, a vehicle 100 is configured with a color transformation system 10 and includes one or more imagers 102 disposed along the vehicle 100. The imagers 102 are communicatively coupled to a controller 12 of the vehicle 100 as part of the color transformation system 10. For example, the imagers 102 are configured to communicate image data 104 with the controller 12. The image data 104 generally corresponds to captured images of an external environment surrounding the vehicle 100. The vehicle 100 is also equipped with a user interface or display 106 at which the image data 104 may be displayed. As described in more detail below, the color transformation system 10 is configured to modify a select portion of the image data 104 to advantageously assist colorblind individuals by displaying a transformed or modified image 108 on the display 106.

The color transformation system 10 is configured to provide advantageous assistance to colorblind individuals, while maximizing the processing power and speed of the controller 12. For example, the controller 12 is configured with a color transformation model 14 that is executed by data processing hardware 16 of the controller 12. The color transformation system 10 minimizes the processing demands on the controller 12 by reducing the image data 104 processed by the color transformation model 14, described herein. As a result, the controller 12 executes the color transformation model 14 on a select portion of the image data 104 and generates resultant outputs at speeds approximately one and a half times faster than if the controller 12 were to execute the color transformation model 14 for the entirety of the image data 104.

The controller 12 is also configured with memory hardware 18 that is in communication with the data processing hardware 16. The memory hardware 18 stores instructions that, when executed on the data processing hardware 16, cause the data processing hardware 16 to perform the operations described herein. The memory hardware 18 also stores an image processing library 20 and user profiles 22. The image processing library 20 stores original image data 104a received from the imagers 102 for use by the color transformation model 14. The user profiles 22 may store user data 24 including, but not limited to, colorblind datapoints, that may be utilized by the color transformation model 14 to generate a transformed image 108. The user profiles 22 may be continuously updated via inputs received from a user and/or through repeated operation of the color transformation model 14.

The controller 12 is also configured with a target detection model 26 configured to identify at least one target 28 from the image data 104. The target 28 may be an object within the image data 104 that may be advantageously identified using the target detection model 26. For example, the target 28 may include, but is not limited to, stop signs, street signs, directional signs, or any other pertinent road signage among other objects. The memory hardware 18 may store a target database 30 and object types 32 that may be utilized by the target detection model 26 to identify the target 28. For example, the target detection model 26 is configured to compare the image data 104 with the target database 30 to identify one or more targets 28. For example, the target detection model 26 may be you only look once (YOLO) model that identifies a bounding box or region of interest 34 of the target 28. The target detection model 26 may receive, in response, one or more object types 32 based on the comparison of the image data with the target database 30.

Once the target(s) 28 has been identified, the target detection model 26 generates the region of interest 34 of the image data 104 based on and proximate to the identified target 28. For example, generating the region of interest 34 may be accomplished by cropping the image data 104. The region of interest 34 is an area that surrounds the identified target 28 but is less than the entirety of the image data 104. The region of interest 34 is generated by the target detection model 26 applying a preset padding 36 to the target 28. The preset padding 36 corresponds to the amount of padding (i.e., pixels) around each region of interest 34 that include the surrounding pixels. The target detection model 26 may generate padded coordinates 36a that are utilized to provide the target detection model 26 with coordinates 34a associated with the region of interest 34, such that the target detection model 26 may utilize the preset padding 36 to crop the region of interest 34 from the image data 104.

The color transformation model 14 is only executed at the region of interest 34, such that only a portion of the image data 104 undergoes color transformation 38. As a result, the controller 12 advantageously saves processing power and is able to execute the color transformation model 14 at an improved rate as compared to executing the color transformation 38 for the entirety of the image data 104. The color transformation model 14 executes the color transformation 38 on the generated region of interest 34, including the target 28, to output a transformed region of interest 40. The transformed region of interest 40 has an altered color as compared to the generated region of interest 34, as the transformed region of interest 40 has undergone the color transformation 38. The altered color of the transformed region of interest 40 is designed to accommodate colorblind individuals by adjusting the colors at the region of interest 34 to reflect a series of colors more readily identifiable by a colorblind individual. The transformed region of interest 40 is displayed on the user interface 106 of the vehicle 100 to assist the user in readily identifying the target 28.

With further reference to FIGS. 1-4, the color transformation model 14 includes at least one of a localized daltonization function 50 and a localized generative adversarial network (GAN) 52. The localized daltonization function 50 is configured to daltonize an identified region of interest 34 of the image data 104. Daltonization is a process that adjusts colors in an image to make the image more distinguishable to colorblind individuals. For example, daltonization is designed to adjust colors in images and visual media to make the colors more distinguishable for people with color vision deficiencies. The GANs operate in a manner similar to daltonization in that the colors in an image are adjusted to make the image more distinguishable for colorblind individuals. GANs are also designed for image-to-image translation tasks by utilizing a conditional adversarial network structure.

The color transformation model 14 may, in some instances, execute the localized daltonization function 50 on the region of interest 34 to define the transformed region of interest 40. As described above, the localized daltonization function 50 is only executed at the region of interest 34 of the image data 104. For example, the region of interest 34 is cropped from the image data 104 prior to execution of the localized daltonization function 50. Once cropped, the localized daltonization function 50 is executed on the region of interest 34 to generate the transformed region of interest 40.

The generated region of interest 34 of the image data 104 is replaced with the transformed region of interest 40. For example, the generated region of interest 34 was cropped from the image data 104, and the transformed region of interest 40 is inserted by the color transformation model 14 to fill an empty region left by the cropped, generated region of interest 34. As mentioned above, the transformed region of interest 40 has an altered color as compared to the generated region of interest 34 as a result of the color transformation 38. The altered color of the transformed region of interest 40 advantageously assists colorblind individuals in identifying targets 28.

The target detection model 26 may also upload the image data 104 to the image processing library 20 stored in the memory hardware 18. The image processing library 20 may include both original regions of interest 34 and transformed regions of interest 40. The image processing library 20 may be utilized by the color transformation model 14 as a reference when executing the color transformation 38. The color transformation model 14 is configured to output the transformed region of interest 40 and to replace the generated region of interest 34 with the transformed region of interest 40. For example, the transformed region of interest 40 is inserted into an original image 104a of the image data 104 to define a modified image 108. The modified image 108 may be saved to an output path 54 of the color transformation model 14. The output path 54 may be utilized by the color transformation model 14 for future execution of color transformation 38.

In other examples, the color transformation model 14 may be configured to execute the localized GAN 52. The localized GAN 52 operates in tandem with a machine learning operation 56 of a machine learning model 58. The machine learning model 58 includes a model trainer 60 configured to train the machine learning model 58 based on training data 62 from, for example, the image processing library 20. For example, the training data 62 may include standard images 104a (i.e., original images 104a) of image data 104 and color adjusted images 108 (i.e., modified images 108). The standard images 104a and the color adjusted images 108 may be stored as paired images 64 as part of the image processing library 20. The paired images 64 may be extracted as training data 62 by the model trainer 60 for the machine learning model 58.

The machine learning model 58 is trained with the paired images 64, and the data processing hardware 16 executes the machine learning function 56 of the machine learning model 58. The machine learning function 56 may include execution of the model trainer 60 to train the machine learning model 58 using the paired images 64. The machine learning function 56 may also map an input image 104a (i.e., original image 104a) from the image data 104 to an output image 108 (i.e., modified image 108) corresponding to a color adjusted image. The model trainer 60 continues to execute the machine learning function 56 until the machine learning model 58 learns to map the input image 104a to the output image 108.

The machine learning model 58 may be configured with a generator 66 designed to create a translation between the input image 104a and the output image 108 and a discriminator 68. The discriminator 68 is configured to evaluate the accuracy of the generator 66 by evaluating the translation from the input image 104a to the output image 108. If deemed accurate, the machine learning model 58 stores the paired images 64 in the image processing library 20. The model trainer 60 utilizes the paired images 64 to train the localized GAN function 52 of the color transformation model 14 using the machine learning model 58. For example, the localized GAN function 52 is trained to learn the color transformation 38 based on the paired images 64 learned by the machine learning function 56.

The color transformation model 14 may execute the localized GAN function 52 on the region of interest 34 to define the transformed region of interest 40. The localized GAN function 52 advantageously provides the color transformation model 14 with the ability to customize the color transformation 38 based on the user profile 22. For example, the machine learning model 58 may be trained using a specific user profile 22 to improve the color transformation 38 based on the user data 24 available. For example, executing the localized GAN function 52 may include identifying a user profile 22 and customizing the color transformation 38 based on the user profile 22.

The trained machine learning model 58 may also be utilized to generate the transformed region of interest 40. The machine learning model 58 and the color transformation model 14 are scalable, such that each can adapt to new image data 104 using real-time adjustment. Thus, the color transformation model 14 may operate utilizing both standard color adjusted images 108 in addition to the user data 24 to more efficiently produce the transformed region of interest 40. As mentioned above, the generated region of interest 34 of the image data 104 is cropped from the image data 104 prior to color transformation 38, and the transformed region of interest 40 replaces the generated region of interest 34 that was cropped from the image data 104.

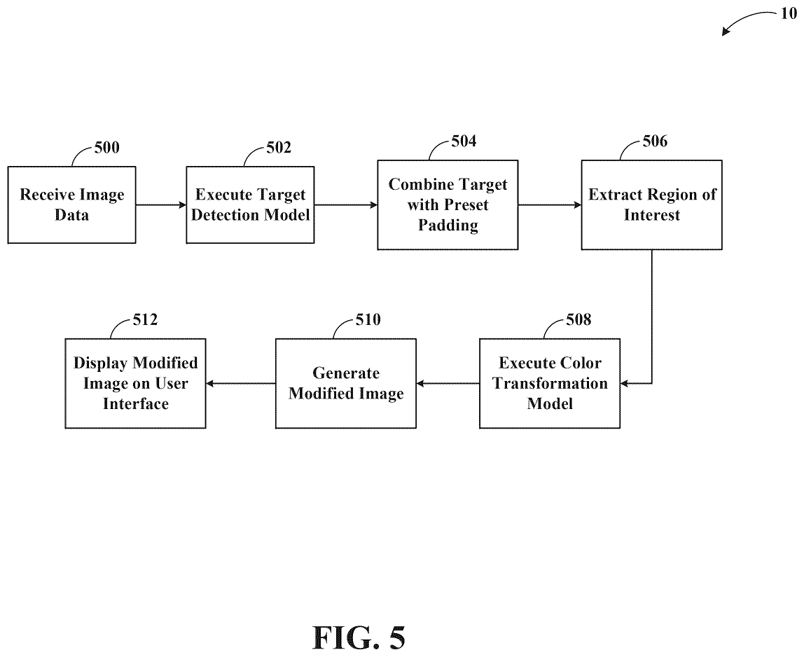

Referring now to FIG. 5, an exemplary flow diagram of the color transformation system 10 is illustrated. At 500, the image data 104 is received at the controller 12. The controller 12 executes, at 502, the target detection model 26. At 504, the identified target 28 is combined with the preset padding 36, and at 506, the region of interest 34 is extracted. The color transformation model 14 is executed, at 508, to generate, at 510, the modified image 108. The modified image 108 is then displayed, at 512, on the user interface 106 of the vehicle 100.

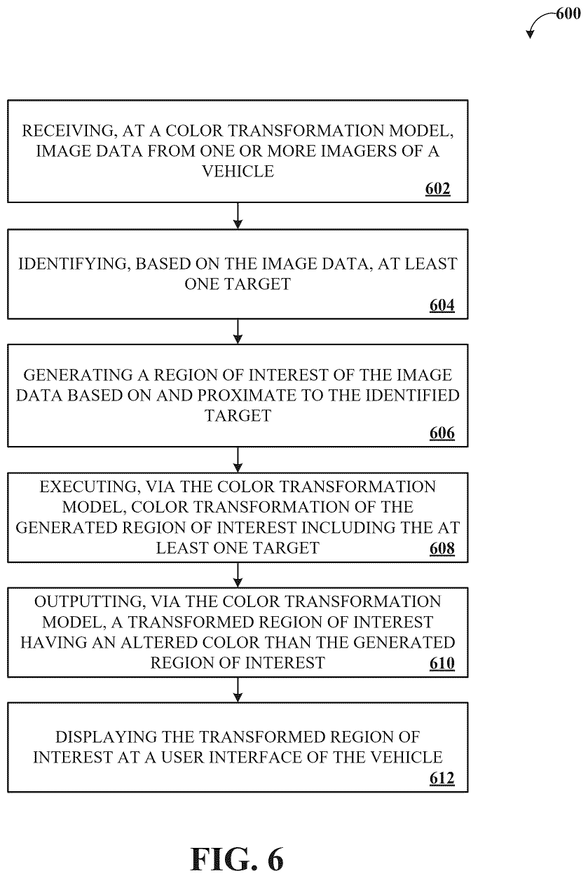

Referring now to FIG. 6, an exemplary method 600 of execution of the color transformation system 10 is illustrated. At 602, a color transformation model 14 receives image data 104 from one or more imagers 102 of a vehicle 100. At 604, at least one target 28 is identified based on the image data 104. A region of interest 34 of the image data 104 is generated, at 606, based on and proximate to the identified target 28. At 608, the color transformation model 14 executes color transformation 38 of the generated region of interest 34 including the at least one target 28. The color transformation model 14 outputs, at 610, a transformed region of interest 40 having an altered color than the generated region of interest 34. At 612, the transformed region of interest 40 is displayed at a user interface 106 of the vehicle 100.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A computer-implemented method when executed by data processing hardware causes the data processing hardware to perform operations comprising:
receiving, at a color transformation model, image data from one or more imagers of a vehicle;
identifying, based on the image data, at least one target;
generating a region of interest of the image data based on and proximate to the identified target;
executing, via the color transformation model, color transformation of the generated region of interest including the at least one target;
outputting, via the color transformation model, a transformed region of interest having an altered color than the generated region of interest; and
displaying the transformed region of interest at a user interface of the vehicle.

2. The method of claim 1, wherein identifying the at least one target includes executing a target detection model.

3. The method of claim 1, wherein generating the region of interest includes applying a preset padding to the identified at least one target.

4. The method of claim 1, wherein executing the color transformation includes executing a localized daltonization function on the region of interest.

5. The method of claim 1, wherein executing the color transformation includes executing a localized generative adversarial network (GAN) function on the region of interest.

6. The method of claim 5, wherein executing the localized GAN function includes identifying a user profile and customizing the color transformation based on the user profile.

7. The method of claim 5, further including training a machine learning model of the color transformation model with paired images, the paired images including standard images and color adjusted images.

8. A color transformation system for a vehicle, the color transformation system comprising:
data processing hardware; and
memory hardware in communication with the data processing hardware, the memory hardware storing instructions that when executed on the data processing hardware cause the data processing hardware to perform operations comprising:
receiving, at a color transformation model, image data from one or more imagers of the vehicle;
identifying, based on the image data, at least one target;
generating, via a target detection model, a region of interest of the image data based on and proximate to the identified target;
cropping, via the color transformation model, the image data at the generated region of interest;
executing, via the color transformation model, a localized daltonization function on the region of interest to define a transformed region of interest; and
replacing the generated region of interest of the image data with the transformed region of interest, the transformed region of interest having an altered color than the generated region of interest.

9. The color transformation system of claim 8, further including uploading the image data to an image processing library stored in the memory hardware.

10. The color transformation system of claim 8, wherein generating the region of interest includes extracting, via the color transformation model, coordinates of the region of interest.

11. The color transformation system of claim 10, further including generating, via the target detection model, padded coordinates of preset padding.

12. The color transformation system of claim 8, wherein replacing the region of interest with the transformed region of interest includes inserting the transformed region of interest into an original image of the image data to define a modified image.

13. The color transformation system of claim 12, further including saving the modified image to an output path of the color transformation model.

14. The color transformation system of claim 8, wherein identifying the at least one target includes comparing the image data with a target database.

15. The color transformation system of claim 14, further including receiving, at the target detection model, object types based on the comparison of the image data with the target database, the object types including the at least one target.

16. A color transformation system for a vehicle, the color transformation system comprising:
data processing hardware; and
memory hardware in communication with the data processing hardware, the memory hardware storing instructions that when executed on the data processing hardware cause the data processing hardware to perform operations comprising:
receiving, at a color transformation model, image data from one or more imagers of the vehicle;
identifying, based on the image data, at least one target;
generating, via a target detection model, a region of interest of the image data based on and proximate to the identified target;
executing, via the color transformation model, a machine learning function of a machine learning model;
mapping, via the machine learning function, an input image from the image data to an output image, the output image corresponding to a color adjusted image;
cropping, via the color transformation model, the image data at the generated region of interest;
executing, via the color transformation model, a localized generative adversarial network (GAN) function on the region of interest to define a transformed region of interest; and
replacing the generated region of interest of the image data with the transformed region of interest, the transformed region of interest having an altered color than the generated region of interest.

17. The color transformation system of claim 16, wherein executing the localized GAN function includes identifying a user profile and customizing the color transformation based on the user profile.

18. The color transformation system of claim 16, further including training a machine learning model of the color transformation model with paired images, the paired images including standard images and color adjusted images.

19. The color transformation system of claim 18, further including passing the cropped image data through the trained machine learning model.

20. The color transformation system of claim 19, wherein executing the localized GAN function includes generating the transformed region of interest using the trained machine learning model.
